(19) United States
(12) Patent Application Publication
(10) Pub. No.: US 2011/0120622 A1
(43) Pub. Date: May 26, 2011

(54) APPARATUS AND METHOD FOR WELDING A WORKPIECE

(75) Inventor: HARTMUT MOEGLICH, Ettlingen (DE)

(73) Assignee: TELSONIC HOLDING AG, Bronschhofen (CH)

(21) Appl. No.: 12/943,489

(22) Filed: Nov. 10, 2010

(30) Foreign Application Priority Data
Nov. 25, 2009 (DE) 10 2009 047 138.3

(51) Int. Cl. B29C 65/06; B29C 65/00

(52) U.S. Cl. 156/73.5; 156/580.1; 156/378; 156/498

(57) ABSTRACT

Apparatus for welding a workpiece includes an ultrasonic welding device, and a thermal welding device, wherein the ultrasonic welding device and the thermal welding device are moveable towards one another so as to act on opposite sides of the workpiece. While the thermal welding device heats the workpiece to a suitable temperature, the ultrasonic welding device executes the welding operation. Heating and welding may hereby be carried out simultaneously or successively.

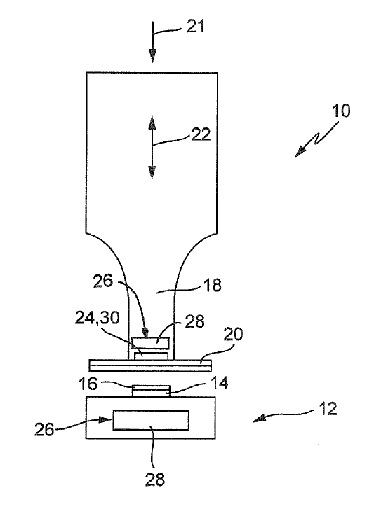

### CROSS-REFERENCES TO RELATED APPLICATIONS

This application claims the priority of German Patent Application, Serial No. 10 2009 047 138.3, filed Nov. 25, 2009, pursuant to 35 U.S.C. 119(a)-(d), the content of which is incorporated herein by reference in its entirety as if fully set forth herein.

### BACKGROUND OF THE INVENTION

The present invention relates to an apparatus and method of welding a workpiece, in particular a workpiece in the form of thin plastic films or multilayered plastic films, such as gusseted bags.

The following discussion of related art is provided to assist the reader in understanding the advantages of the invention, and is not to be construed as an admission that this related art is prior art to this invention.

To ensure clarity, it is necessary to establish the definition of several important terms and expressions that will be used throughout this disclosure. The term “thermal welding” of a workpiece relates to hot pressing of films or foils, in particular plastic films. Operations that include hot pressing involve in particular a joining/connecting process such as welding, laminating, sealing, or a separation process such as cutting, separation sealing, fusion, or a shaping process such as compressing, drawing, notching.

German patent document DE 198 15 763 A1 discloses a welding tool for welding plastic films, using heat impulse welding technique. The welding tool has a heating unit essentially including a rail and a heating band which is secured to the rail, with a thermal insulation being provided between the rail and the heating band. The heating unit is firmly pressed onto the films to be welded together, and the heating band is then subjected to a pulsed current via a pulse generator and heated. As a result, the films are heated and welded together. A problem associated with this welding method is the presence of potential contaminants that adversely affect the welding process and may even lead to an inadequate joining of surfaces being welded together, especially, when plastic bags (pouch) are involved that are open on one side and filled with contents beforehand.

It would therefore be desirable and advantageous to address this problem and to obviate other prior art shortcomings by ensuring a reliable welding operation of films or foils.

### SUMMARY OF THE INVENTION

According to one aspect of the present invention, an apparatus for welding a workpiece includes an ultrasonic welding device, and a thermal welding device, wherein the ultrasonic welding device and the thermal welding device are moveable towards one another so as to act on opposite sides of the workpiece.

According to another aspect of the present invention, a method of welding a workpiece includes the steps of moving an ultrasonic welding device and a thermal welding device towards one another so as to act on opposite sides of the workpiece.

The present invention resolves prior art problems by using an ultrasonic welding device in addition to the thermal welding device in order to weld a workpiece, such as plastic films for example. The presence of the ultrasonic welding device provides a cleaning effect to ensure optimal conditions for welding surfaces, e.g. bag edges. Moreover, another benefit involves the welding of thin films. These films typically exhibit smaller damping behavior so that the application of ultrasound is inadequate to weld them together. By heating the thin films beforehand or simultaneously with the thermal welding device, the films receive a greater absorption rate for ultrasound, thereby significantly improving the welding quality. In addition, thin films or hard films become softer when subjected to heating with the thermal welding device so that the risk of damage during ultrasonic welding is markedly decreased.

According to another advantageous feature of the present invention, the thermal welding device may be implemented as a pulse welding device. Pulse welding has the benefit to enable a very exact control of energy being introduced into the workpiece. Suitably, the thermal welding device includes a sensor to monitor the temperature and to control the energy supply of the thermal welding device.

According to another advantageous feature of the present invention, the ultrasonic welding device may include a sonotrode, with a counter tool being placed in opposite disposition to the sonotrode, and with the workpiece being positioned in-between, wherein the thermal welding device may be integrated in the sonotrode or the counter tool. Of course, a second thermal welding device may also be integrated in the other one of the sonotrode and the counter tool.

According to another advantageous feature of the present invention, the thermal welding device may include an electrically heatable coating or a heatable shoe, placed in confronting relationship to one of the opposite sides of the workpiece.

According to another advantageous feature of the present invention, the counter tool may include a cooling unit which is placed adjacent to the thermal welding device for cooling the workpiece after the workpiece has been welded. As a result, the welded zone receives quickly a sufficient strength after the workpiece underwent the welding operation so that the welding tool can be opened earlier and the workpiece removed faster. The operating cycle is therefore shortened by the presence of the cooling unit, so that a greater number of workpieces can be processed during a same time period compared to an apparatus without cooling unit.

According to another advantageous feature of the present invention, the cooling unit may have a cooling channel for circulation of a coolant, e.g. cooling gas or water. As an alternative or in addition, compressed air may also be blown towards the workpiece.

According to another advantageous feature of the present invention, the ultrasonic welding device and the thermal welding device may be operated simultaneously or alternatingly. For example, the thermal welding device may continue to operate after the films have been heated. Moreover, it is conceivable to provide cooling on one side with the cooling unit, while using ultrasound to weld on the other side, if the situation warrants such a procedure.

According to another advantageous feature of the present invention, the thermal welding device may be heated and cooled alternatingly.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows a side view of a welding apparatus according to the present invention.

### DETAILED DESCRIPTION OF PREFERRED EMBODIMENTS

The depicted embodiment is to be understood as illustrative of the invention and not as limiting in any way. It should also be understood that the FIGURE is not necessarily to scale and that the embodiment may be illustrated by graphic symbols, phantom lines, diagrammatic representations and fragmentary views. Details which are not necessary for an understanding of the present invention or which render other details difficult to perceive may have been omitted.

Turning now to the FIGURE, there is shown a side view of a welding apparatus according to the present invention, including an ultrasonic welding device, generally designated by reference numeral 10, and a counter tool, generally designated by reference numeral 12. A workpiece 20 is placed between the ultrasonic welding device 10 and the counter tool 12. The ultrasonic welding device 10 includes a sonotrode 18 which involves an acoustic tool inducing ultrasonic vibration into the workpiece 20 by applying pressure and oscillating micro-movement. The workpiece 20 may, for example, involve two thin plastic films which are intended to be welded together.

The counter tool 12 is equipped with a thermal welding device 14 which includes a coating 16 that can be heated electrically and is placed in confronting relationship to a bottom side of the workpiece 20 (or lower one of the plastic films). When the ultrasonic welding device 10 and the counter tool 12 with the thermal welding device 14 are moved toward one another in the direction of the workpiece 20, the contact pressure 21 applied by the sonotrode 18 and the ultrasonic welding energy, aligned in the direction of double arrow 22, act on the topside of the workpiece 20, whereas the heat energy of the thermal welding device 14 acts on the bottom side of the workpiece 20. Thus, the workpiece 20 is first thermally heated and then welded by ultrasound. Of course, it is certainly conceivable to implement the thermal heating and the welding by ultrasound at a same time, i.e. the supply of ultrasonic energy is accompanied by a simultaneous supply of thermal energy. The supply of thermal energy may hereby change with respect to time.

As shown by way of example in the FIGURE, a further thermal welding device 24 may be provided in the welding surface of the sonotrode 18. The thermal welding device 24 may hereby include a heatable brake shoe 30 so that the workpiece 20 can be thermally heated on both sides. An example of a thermal welding device 14, 24 includes a pulse welding device.

As further shown by way of example in the FIGURE, the counter tool 24 may include a cooling unit, generally designated by reference numeral 26 and placed underneath the thermal welding device 14. The cooling unit 26 includes a cooling channel 28 through which a coolant, e.g. a cooling gas or a liquid, e.g. water, flows. The provision of the cooling unit 26 enables a cooling of the workpiece 20 immediately after undergoing the welding operation. As a result, the processing cycle is shortened. It is, of course, also conceivable to provide such a cooling unit 26 having a cooling channel 28 in the sonotrode 18. Suitably, a cooling gas flows through this cooling channel 28.

While the invention has been illustrated and described in connection with currently preferred embodiments shown and described in detail, it is not intended to be limited to the details shown since various modifications, combination of features and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. Apparatus for welding a workpiece, comprising:
an ultrasonic welding device; and
a thermal welding device,
wherein one of the ultrasonic welding device and the thermal welding device or both are moveable in relation to the workpiece to act at least on one side of the workpiece.

2. The apparatus of claim 1, wherein the ultrasonic welding device and the thermal welding device are arranged on opposite sides of the workpiece and movable towards one another so as to act on both sides of the workpiece.

3. The apparatus of claim 1, wherein the thermal welding device is integrated in the ultrasonic welding device so that the ultrasonic welding device and the thermal welding device act on a same side of the workpiece.

4. The apparatus of claim 1, wherein the workpiece comprises two plastic films.

5. The apparatus of claim 1, wherein the thermal welding device is a pulse welding device.

6. The apparatus of claim 1, wherein the thermal welding device includes a sensor to monitor the temperature and to control the energy supply of the thermal welding device.

7. The apparatus of claim 1, wherein the ultrasonic welding device includes a sonotrode, and further comprising a counter tool placed in opposite disposition to the sonotrode, with the workpiece being positioned in-between, said thermal welding device being integrated in one member selected from the group consisting of the sonotrode and the counter tool.

8. The apparatus of claim 7, further comprising a second said thermal welding device integrated in the other member selected from the group consisting of the sonotrode and the counter tool.

9. The apparatus of claim 1, wherein the thermal welding device includes an electrically heatable coating placed in confronting relationship to the side of the workpiece.

10. The apparatus of claim 1, wherein the thermal welding device includes a heatable shoe placed in confronting relationship to the side of the workpiece.

11. The apparatus of claim 8, wherein at least one of the thermal welding devices and the counter tool includes a cooling unit for cooling the workpiece after the workpiece has been welded.

12. The apparatus of claim 7, wherein the thermal welding device is integrated in the cooling tool, said counter tool including a cooling unit placed adjacent to the thermal welding device for cooling the workpiece after the workpiece has been welded.

13. The apparatus of claim 12, wherein the cooling unit has a cooling channel for circulation of a coolant.

14. The apparatus of claim 13, wherein the coolant is a cooling gas or water.

15. The apparatus of claim 7, wherein the sonotrode includes a cooling channel for circulation of a coolant to cool the workpiece after the workpiece has been welded.

16. The apparatus of claim 15, wherein the coolant is a cooling gas.

17. A method of welding a workpiece, comprising the steps of moving an ultrasonic welding device and a thermal welding device in relation to a workpiece so as to act on at least one side of the workpiece.

18. The method of claim 17, wherein the ultrasonic welding device and the thermal welding device move towards one another to act on opposite sides of the workpiece.

19. The method of claim 17, wherein the workpiece comprises two plastic films.

20. The method of claim 17, wherein the ultrasonic welding device and the thermal welding device are operated simultaneously or alternatingly.

21. The method of claim 17, wherein the ultrasonic welding device is operated to execute a welding process after the thermal welding device has heated the workpiece.

22. The method of claim 17, further comprising the step of alternatingly heating and cooling the thermal welding device.
